(19) United States
(12) Patent Application Publication
(10) Pub. No.: US 2006/0134361 A1
(43) Pub. Date: Jun. 22, 2006

(54) Low-permeable composite hose

(76) Inventor: Nobuaki Niki, Inuyama-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/311,210

(22) Filed: Dec. 19, 2005

(30) Foreign Application Priority Data
Dec. 21, 2004 (JP) 2004-370252

(51) Int. Cl. B32B 1/08

(52) U.S. Cl. 428/36.91

(57) ABSTRACT

A first metal laminate sheet in a form of strip is rolled into a cylindrical shape to form a first impermeable layer. A first gap is defined between widthwise opposite edges of the first metal laminate sheet. Then, a second metal laminate sheet in a form of strip is rolled into a cylindrical shape on an outer periphery of the first metal laminate sheet, with intervening a rubber elastic layer therebetween, to form a second impermeable layer. A second gap is also defined between widthwise opposite edges of the second metal laminate sheet. The first gap and the second gap are staggered with respect to each other in a circumferential direction.

### TECHNICAL FIELD

1. Field of the Invention

The present invention relates to a composite hose, more specifically, a low-permeable composite hose including an impermeable layer to an internal fluid, which is adapted for a hose for piping in a motor vehicle such as a gasoline fuel hose, a refrigerant hose for an air conditioner, or a hose for a fuel cell.

2. Description of the Related Art

Recently, in view of global environmental protection, low-permeability to an internal fluid is strongly required for piping in a motor vehicle. For example, it has been required to take measures for preventing dispersing in air an internal fluid such as gasoline fuel or carbon dioxide refrigerant. It is known that a hose is constructed by using a metal laminate sheet including a metal foil or a metal evaporated layer in order to satisfy such requirement for low-permeability to the internal fluid. The metal laminate sheet is capable of sufficiently blocking a high-permeable fluid of small molecule size. In the hose, an impermeable metal laminate layer is formed by rolling the metal laminate sheet. In this construction of the hose, it is effectively prevented that the internal fluid permeates out by the metal foil or the metal evaporated layer of the metal laminate layer that is formed in an elongate cylindrical shape. And, as a metal material is adapted for the metal laminate layer in a form of thin film i.e., the metal foil or the metal evaporated layer, formation of the metal laminate layer does not adversely affect flexibility of the hose.

Meanwhile, in such construction that the metal laminate layer is constructed by rolling a metal laminate sheet, in order to secure impermeability, end portions or lateral end portions of the metal laminate sheet are overlapped each other, and bonded together by adhesive agent. For example, in case where the metal laminate layer is constructed by rolling a metal laminate sheet in a form of tape or strip into a cylindrical shape so that widthwise or lateral opposite edges thereof extend in a longitudinal direction of the hose, widthwise opposite end portions thereof are overlapped each other and bonded by adhesive agent (for example, refer to Patent Document 1). In case where the metal laminate layer is constructed by spirally winding the metal laminate sheet strip or tape around the hose body, both side end portions thereof are overlapped and bonded together by an adhesive agent.

[Patent Document 1] JP-A, 2001-227681

However, typically, a layer of the adhesive agent is thin and is low in elasticity or elastic property. So, in such construction that the metal laminate layer is constructed by overlapping widthwise opposite end portions or both side end portions of the metal laminate sheet each other and bonding or attaching them together by adhesive agent, a separation is created in overlapped portions of the metal laminate sheet while the composite hose is largely bent or curved and deformed repeatedly, resulting that impermeability of the metal laminate layer is deteriorated or lowered. Further, there is a fear that with separation in the overlapped portions, the metal laminate sheet is expandingly damaged. Specifically, in the composite hose including the metal laminate layer constructed by rolling the metal laminate sheet in a form of strip into a cylindrical shape so that widthwise opposite edges extend in the longitudinal direction, damage of the metal laminate sheet tends to expand once the separation is created in the overlapped portions of the metal laminate sheet.

The reason is that the metal laminate sheet has a strong spring back force. And, consequently, there is a possibility that impermeability of the metal laminate layer is largely deteriorated at an early stage. Namely, in this hose, there exists a problem of durability. And, in the composite hose including the metal laminate layer constructed by rolling spirally the metal laminate sheet in the form of strip, an entire length of the overlapped portion becomes considerably long, and as a result separated spots tend to be created increasingly in the overlapped portion. Then, in many spots along the overlapped portion, expansion of damage of the metal laminate sheet due to or associated with the separation in the overlapped portion tends to be created, and as a result, there is also a possibility that impermeability of the metal laminate layer is largely deteriorated at an early stage. Namely, in such hose, there also exists a problem of durability.

So, recently, there is a demand for a composite hose that has a characteristic allowing to convey a fluid of very small molecule size such as hydrogen over a long period of time without permeating it out. Such composite hose is preferably adapted, for example, for a fuel cell.

The present invention is made under the foregoing circumstances. It is an object of the present invention to provide a durable low-permeable composite hose including an impermeable layer of a metal laminate sheet or a metal laminate layer that keeps excellent low-permeability over a long period of time.

### SUMMARY OF THE INVENTION

According to the present invention, there is provided a novel low-permeable composite hose, for example, having a plurality of impermeable layers, each is formed from a metal laminate sheet. The low-permeable composite hose comprises a first impermeable layer formed by rolling a first metal laminate sheet in a form of strip (including a tape or a rectangular shape) into a cylindrical shape so that widthwise opposite edges of the first metal laminate sheet extend in a longitudinal direction of a hose (a longitudinal direction of the low-permeable composite hose), a second impermeable layer formed on an outer side of the first impermeable layer by rolling a second metal laminate sheet in the form of strip (including a tape or a rectangular shape) into a cylindrical shape so that widthwise opposite edges of the second metal laminate sheet extend in the longitudinal direction of the hose, and a rubber elastic layer interposed between the first and the second impermeable layers. A first gap is defined between the widthwise opposite edges of the first metal laminate sheet in the first impermeable layer, and a second gap is defined between the widthwise opposite edges of the second metal laminate sheet in the second impermeable layer. For example, the first gap may be a circumferential or widthwise gap, and the second gap may be a circumferential or widthwise gap. And, the widthwise opposite edges of the first metal laminate sheet and the widthwise opposite edges of the second metal laminate sheet are disposed so as to be staggered with respect to each other in a circumferential direction or position. That is, for example, the first gap (defined between the widthwise opposite edges of the first metal laminate sheet) and the second gap (defined between the widthwise opposite edges of the second metal laminate sheet) are disposed so as to be staggered with respect to each other in the circumferential direction. The first and the second metal laminate sheets are formed, for example, from a laminating sheet (a sheet for lamination) including a metal foil or a metal evaporated layer. The first and the second metal laminate sheets may be constructed by laminating the metal foil, the metal foil and a reinforcing material, or the metal evaporated layer with a resin film. Such first and second metal laminate sheets are formed, for example, in a strip or tape with a narrow width, and are rolled into a cylindrical shape so that widthwise opposite edges extend in the longitudinal direction of the hose to define the first impermeable layer and the second impermeable layer on an outer side of the first impermeable layer, respectively. The low-permeable composite hose of the present invention is constructed, for example, so as to have the first and the second impermeable layers between an inner surface rubber elastic layer and an outer surface rubber elastic layer.

In the first impermeable layer, the gap is defined between the widthwise opposite edges of the first metal laminate sheet, and in the second impermeable layer, the gap is defined between the widthwise opposite edges of the second metal laminate sheet. Therefore, when the composite hose is largely bent and deformed repeatedly, it does not happen that damage prevails in a wide area of the first or the second metal laminate sheet due to separation at the widthwise opposite end portions of the first or the second metal laminate sheet. And also, it does not happen that damage is caused in the first or the second metal laminate sheet due to contact or abutment between the widthwise opposite end portions of the first or the second metal laminate sheet. As the widthwise opposite edges of the first metal laminate sheet and the widthwise opposite edges of the second metal laminate sheet are disposed so as to be staggered each other in a circumferential direction, the first gap between the widthwise opposite edges of the first metal laminate sheet is overlapped or overlaid by a portion of the second metal laminate sheet other than the widthwise opposite edges thereof. And, as the rubber elastic layer is interposed between the first and the second impermeable layers, the rubber elastic layer air-tightly blocks between the widthwise opposite edges (the first gap) of the first metal laminate sheet and the widthwise opposite edges (the second gap) of the second metal laminate sheet. Therefore, an internal fluid that passes through between the widthwise opposite edges of the first metal laminate sheet is blocked by the second metal laminate sheet, and cannot escape radially outward. Only way for the internal fluid to escape radially outward is to permeate or creep through the rubber elastic layer in a circumferential direction to reach between the widthwise opposite edges of the second metal laminate sheet. That means, a fluid impermeable construction here is like a fluid impermeable construction where on an outer side of the first metal laminate sheet, instead of the second metal laminate sheet, the rubber elastic layer is laminated that has a thickness equal to a circumferential distance through which the internal fluid permeates to reach between the widthwise opposite edges of the second metal laminate sheet. When the gaps are defined between the widthwise opposite edges of the first metal laminate sheet, and between the widthwise opposite edges of the second metal laminate sheet, respectively, low-permeability of the composite hose may not be deteriorated by properly setting circumferential positions (positions in the circumferential direction) of the widthwise opposite edges of the first metal laminate sheet and of the widthwise opposite edges of the second metal laminate sheet. The first metal laminate sheet is usually sandwiched by the inner rubber elastic layer and the outer rubber elastic layer (the rubber elastic layer interposed between the first and the second impermeable layers).

For the rubber elastic layer, preferably used is rubber elastic material (rubber material or thermoplastic elastomer material) that has a good adhesiveness or good adhesion property with the first and the second metal laminate sheets. The first and the second impermeable layers are bonded or attached by the rubber elastic layer that has a sufficient elasticity so as to be displaceable circumferentially relative to each other. So, when the composite hose is largely bent and deformed repeatedly, separation is hard to be created between the first metal laminate sheet and the rubber elastic layer and between the second metal laminate sheet and the rubber elastic layer. Therefore, impermeability of the composite hose is not easily lowered, and there is no fear that the first and the second metal laminate sheets are greatly damaged.

It is effective that the widthwise opposite edges or the first gap between the widthwise opposite edges of the first metal laminate sheet is located on a diametrically opposite side of the widthwise opposite edges or the second gap between the widthwise opposite edges of the second metal laminate sheet. Namely, it is preferable that the widthwise opposite edges of the second metal laminate sheet is located so as to be angularly displaced by 180° or generally 180° in a circumferential direction relative to the widthwise opposite edges of the first metal laminate sheet. This construction may maximize a circumferential distance between the widthwise opposite edges of the first metal laminate sheet and the widthwise opposite edges of the second metal laminate sheet.

The low-permeable composite hose including an impermeable layer formed from a metal laminate sheet according to the present invention may comprise a plurality of impermeable layers, each formed by rolling a metal laminate sheet in the form of strip or tape into a cylindrical shape so that widthwise opposite edges of the metal laminate sheet extend in a longitudinal direction of a hose, a rubber elastic layer that is interposed between the impermeable layers. For example, the rubber elastic layer is disposed each pair of the adjacent impermeable layers. The impermeable layers are arranged spaced apart, for example, in a radial direction. And a gap is defined between the widthwise opposite edges of the metal laminate sheet in each of the impermeable layers. For example, the gap may be a circumferential or widthwise gap. Each of the metal laminate sheets may be disposed so that the widthwise opposite edges or a gap between the widthwise opposite edges of the metal laminate sheet is staggered with respect to the widthwise opposite edges of an adjacent metal laminate sheet (a radially adjacent metal laminate sheet) in a circumferential direction. Here, for example, the low-permeable composite hose may be constructed to have a first impermeable layer formed from a first metal laminate sheet, a second impermeable layer formed from a second metal laminate sheet and a third impermeable layer formed from a third metal laminate sheet. The rubber elastic layers, each is disposed between the first and the second impermeable layers and between the second and the third impermeable layers. The low-permeable composite hose of the present invention is constructed, for example, to have a plurality of impermeable layers between an inner surface rubber elastic layer and an outer surface rubber elastic layer.

As explained above, in the low-permeable composite hose according to the present invention, a metal laminate sheet is restrained from damage or separation and damage, and thereby an excellent low-permeability may be maintained over a long period of time.

Now, the preferred embodiments of the present invention will be described in detail with reference to the drawings.

### BRIEF DESCRIPTION OF THE DRAWINGS

FIG. 1 is a perspective view for showing a multilayered construction of a low-permeable composite hose according to the present invention.

FIG. 2 is a sectional view for showing the multilayered construction of the low-permeable composite hose according to the present invention.

FIG. 3 (a) is a view for generally or schematically showing a production process of the low-permeable composite hose and illustrating a state that a first metal laminate sheet is placed adjacent to an outer periphery of an inner surface rubber layer.

FIG. 3 (b) is a view for generally or schematically showing the production process of the low-permeable composite hose and illustrating a state that a first impermeable layer is formed on the outer periphery of the inner surface rubber layer.

FIG. 3 (c) is a view for generally or schematically showing the production process of the low-permeable composite hose and illustrating a state that a first middle rubber layer is formed on an outer periphery of the first metal laminate sheet by extrusion.

FIG. 4 (a) is a view for generally or schematically showing the production process of the low-permeable composite hose and illustrating a state that a second metal laminate sheet is placed adjacent to an outer periphery of the first middle rubber layer.

FIG. 4 (b) is a view for generally or schematically showing the production process of the low-permeable composite hose and illustrating a state that a second impermeable layer is formed on the outer periphery of the first middle rubber layer.

### DETAILED DESCRIPTIONS OF PREFERRED EMBODIMENTS

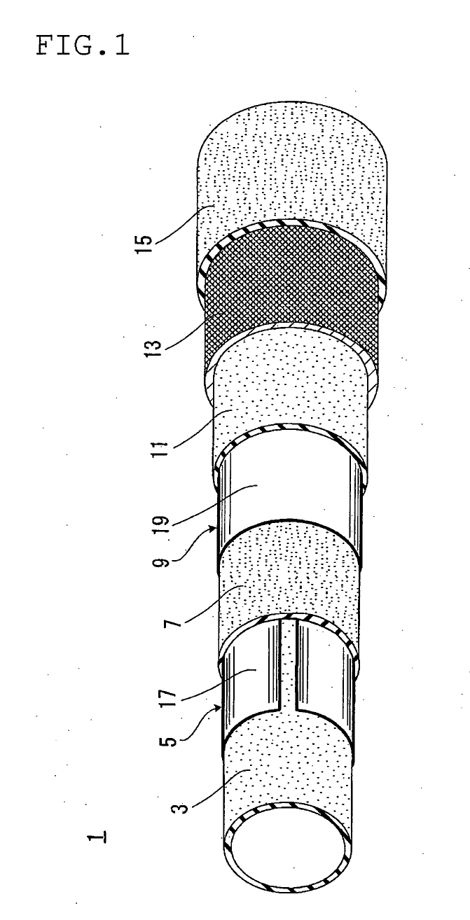

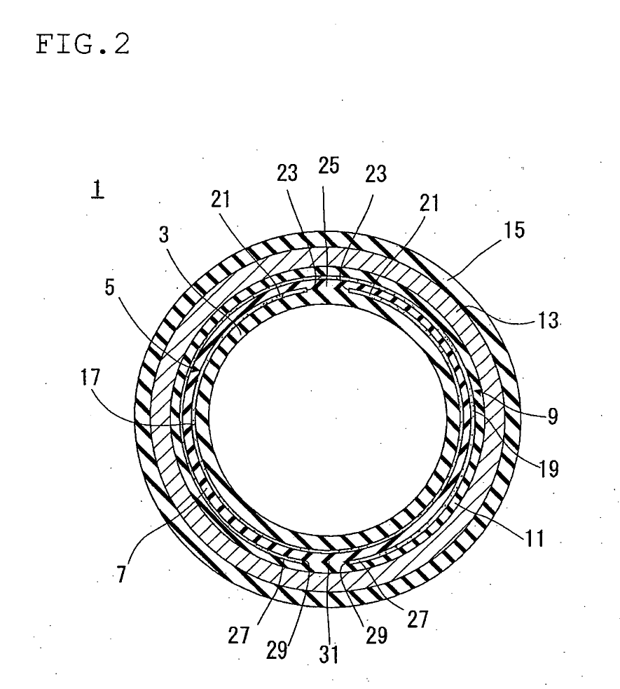

With reference to FIGS. 1 and 2, a multilayered construction of a low-permeable composite hose according to the present invention can be understood well.

A low-permeable composite hose 1 is used, for example, for a piping for a fuel cell in a motor vehicle. The low-permeable composite hose 1 has a multilayered construction including an innermost inner surface rubber layer (inner surface rubber elastic layer) 3, a first impermeable layer 5 disposed on or disposed directly on an outer periphery of the inner surface rubber layer 3, a first middle rubber layer 7 formed on or formed directly on an outer periphery of the first impermeable layer 5, a second impermeable layer 9 disposed on or disposed 1 5 directly on an outer periphery of the first middle rubber layer 7, a second middle rubber layer 11 formed on or formed directly on outer periphery of the second impermeable layer 9, a reinforcing layer 13 provided on or provided directly on an outer periphery of the second middle rubber layer 11, and an outermost outer surface rubber layer (outer surface rubber elastic layer) 15 formed on or formed directly on an outer periphery of the reinforcing layer 13. An inner diameter of the low-permeable composite hose 1 (an inner diameter of the inner surface rubber layer 3) is designed 15 mm, while an outer diameter of the low-permeable composite hose 1 (an outer diameter of the outer surface rubber layer 15) is designed 24.3 mm. The inner surface rubber layer 3, the first middle rubber layer 7, the second middle rubber layer 11 and the outer surface rubber layer 15 have wall-thickness of 1.0 mm, 0.7 mm, 0.7 mm and 1.0 mm, respectively. When the wall-thickness of the first middle rubber layer 7 is made thin, although fluid blocking performance or impermeability is improved between the first impermeable layer 5 and the second impermeable layer 9, extruding performance is lowered. Therefore, typically, the wall-thickness of the first middle rubber layer 7 is preferably in a range of 0.1 mm to 1.0 mm.

For the inner surface rubber layer 3, the first middle rubber layer 7 and the second middle rubber layer 11, used is halogenated butyl rubber (halogenated IIR) that is excellent in impermeability to hydrogen, etc., sufficient in elasticity, and good in adhesion property with the first and second impermeable layers 5, 9 (or resin films of the first and the second impermeable layers 5, 9). However, may be used butyl rubber (IIR), ethylene-propylene rubber (EPM), ethylene-propylene-diene-rubber (EPDM), acrylonitrile-butadiene-rubber (NBR), fluoro rubber (FKM), chlorinated polyethylene (CM), chlorosulfonated polyethylene synthetic rubber (CSM), blend rubber of NBR and polyvinyl chrolide (PVC) (NBR+PVC), acrylic rubber (ACM), or the like. Spcifically, impermeability of a material of the first middle rubber layer 7 is important for securing fluid blocking performance or impermeability between the first impermeable layer 5 and the second impermeable layer 9. It is effective to use the halogenated IIR or IIR for the first middle rubber layer 7. However, when the low-permeable composite hose 1 is used for a gasoline fuel piping, it is preferred to use NBR, (NBR+PVC), FKM or the like for the first middle layer 7.

The first impermeable layer 5 is constructed by rolling the first metal laminate sheet 17, so-called in a fashion for forming a sushi-roll, on an outer periphery of the inner surface rubber layer 3. The second impermeable layer 9 is constructed by rolling the second metal laminate sheet 19, so-called in the fashion for forming a sushi-roll, on an outer periphery of the first middle rubber layer 7. Here, the phrase of the fashion for forming a sushi-roll means that the metal laminate sheet in the form of strip is rolled into a cylindrical shape so that widthwise opposite edges thereof extend in a longitudinal direction of the hose. The first and the second metal laminate sheets 17, 19 are formed respectively by laminating a resin film, polyamide (PA) film on both sides of a metal foil, the aluminum (AL) foil by means of fusion bonding, welding or bonding. The first metal laminate sheet 17 is in a form of elongate strip with width slightly shorter than an outer circumferential length (outer perimeter) of the inner surface rubber layer 3 and, the second metal laminate sheet 19 is in the form of elongate strip with width slightly shorter than an outer circumferential length (outer perimeter) of the first middle rubber layer 7. In the first and the second metal laminate sheets 17, 19, respectively, a reinforcing member such as a wire mesh, a reinforcing fabric member or high-strength film resin may be provided along the AL foil. As for the resin film, may be used a polyethylene terephthalate (PET) film, a polyethylene-vinyl alcohol (EVOH) film, a polyethylene (PE) film or the like. Further, the first and the second metal laminate sheets 17, 19 may be formed by forming an evaporated metal layer, an evaporated aluminum layer on one of resin films, and covering the evaporated aluminum layer with the other of the resin films.

The reinforcing layer 13 may be provided by braiding or spirally winding a reinforcing thread or a metal wire on an outer periphery of the second middle rubber layer 11. For a material of the reinforcing thread, adaptable are PET, polyethylene naphthalate (PEN), aramid, PA, vinylon, rayon, or the like.

For the outer surface rubber layer 15, used is EPDM that is excellent in weather resistance. However, may be usable chloroprene rubber (CR), IIR, halogenated IIR, CSM, CM, rubber-like copolymer of epichlorohydrin and ethylene oxide (ECO), EPM, NBR+PVC, or the like.

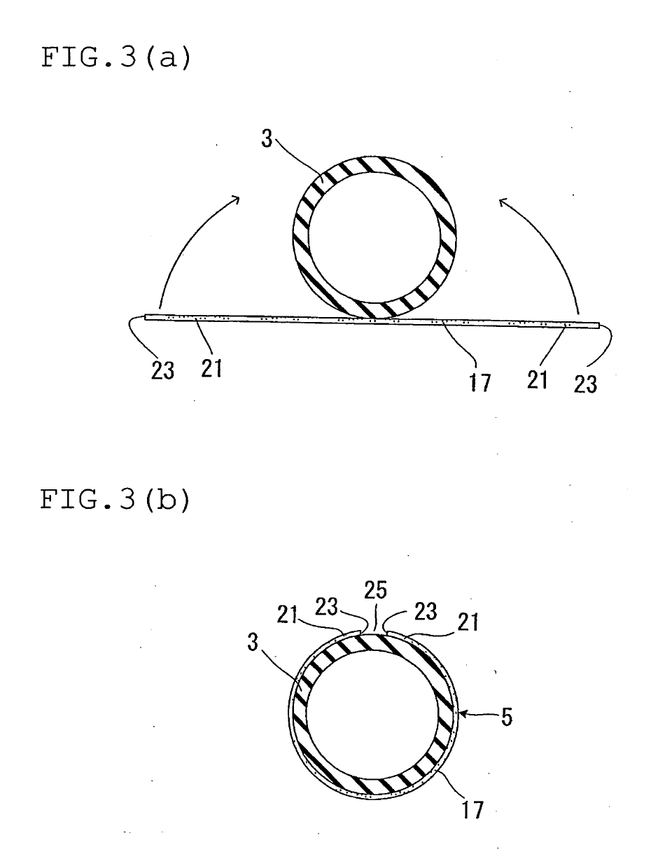

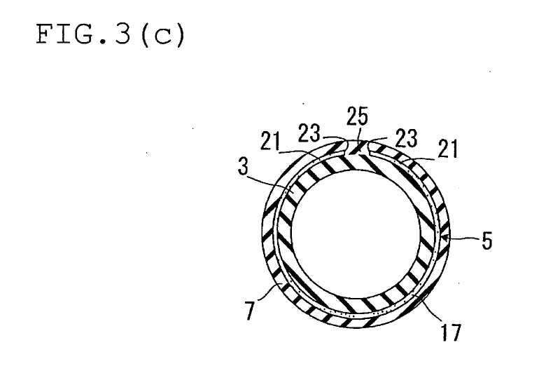

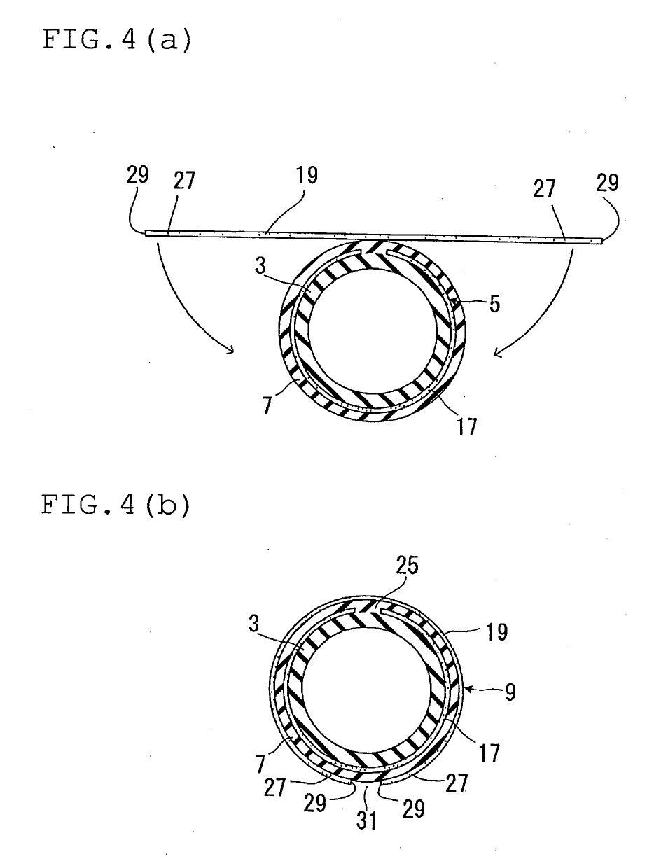

Next, a production method of the low-permeable composite hose 1 is explained with reference to FIGS. 3 and 4. FIG. 3 is a view for explaining steps of laminating the first impermeable layer 5 to the first middle rubber layer 7, and FIG. 4 is a view for explaining steps for laminating the second impermeable layer 9.

First, the first metal laminate sheet 17 in the form of strip is placed adjacent to an outer periphery of the unvulcanized inner surface rubber layer 3 formed in a cylindrical shape (FIG. 3 (a)), and is rolled on or around the inner surface rubber layer 3, so-called in the fashion for forming a sushi-roll, along an entire length of the inner surface rubber layer 3, and thereby the first impermeable layer 5 is formed (FIG. 3 (b)). As the first metal laminate sheet 17 has a width slightly shorter than an outer circumferential length (outer perimeter) of the inner surface rubber layer 3, widthwise opposite end portions 21, 21 of the first metal laminate sheet 17 are not overlapped each other, and a slight gap, namely a first gap (a first circumferential or widthwise gap) 25 is defined between widthwise opposite edges 23, 23 thereof. The first gap 25 extends along a length of the hose 1. The first gap 25 has a width preferably in a range of 1% to 20% of a circumferential length (perimeter). For example, the width of the first gap 25 is designed in a range of 1% to 20% of a circumferential length (perimeter) of the first impermeable layer 5, or in a range of 1% to 20% of the outer circumferential length (outer perimeter) of the inner surface rubber layer 3. When the first gap 25 has a width narrower or shorter than 1% thereof, there is a fear that the widthwise opposite edges 23 of the first metal laminate sheet 17 conflict with each other and are thereby damaged. On the other hand, when the first gap 25 has a width wider or longer than 20% thereof, there is a fear that impermeability of the first impermeable layer 5 is deteriorated. Then, while the first metal laminate sheet 17 is kept rolled, so-called in the fashion for forming a sushi-roll, the first middle rubber layer 7 of a cylindrical shape is formed on an outer periphery of the first metal laminate sheet 17 by extruding (FIG. 3 (c)). Instead, the first middle rubber layer 7 may be thinly laminated over an outer surface of the first metal laminate sheet 17 before the first metal laminate sheet 17 is rolled.

After the first middle rubber layer 7 is formed on the outer periphery of the first metal laminate sheet 17, the second metal laminate sheet 19 in the form of strip is placed adjacent to an outer periphery of the unvulcanized first middle rubber layer 7 (FIG. 4 (a)), and is rolled, so called in the fashion for forming a sushi-roll, on or around the first middle rubber layer 7 along an entire length of the first middle rubber layer 7, and thereby the second impermeable layer 9 is formed (FIG. 4 (b)). As the second metal laminate sheet 19 has a width slightly shorter than an outer circumferential length (outer perimeter) of the first middle rubber layer 7, widthwise opposite end portions 27, 27 of the second metal laminate sheet 19 are not overlapped each other, and a slight gap, namely a second gap (a second circumferential or widthwise gap) 31 is defined between widthwise opposite edges 29, 29 thereof. The second gap 31 extends along the length of the hose 1. The second gap 31 has a width also preferably in a range of 1% to 20% of a circumferential length (perimeter). For example, the width of the second gap 31 is designed in a range of 1% to 20% of a circumferential length (perimeter) of the second impermeable layer 9, or in a range of 1% to 20% of the outer circumferential length (outer perimeter) of the first middle rubber layer 7. When the second gap 31 has a width narrower or shorter than 1% thereof, there is a fear that the widthwise opposite edges 29 of the second metal laminate sheet 19 conflict with each other and are thereby damaged. On the other hand, when the second gap 31 has a width wider or longer than 20% thereof, there is a fear that impermeability of the second impermeable layer 9 is deteriorated. The second metal laminate sheet 19 is rolled, so-called in the fashion for forming a sushi-roll, on or around the first middle rubber layer 7 such that the second gap 31 is located on a diametrically opposite side of the first gap 25 of the first metal laminate sheet 17. In FIG. 4 (b), the first gap 25 is located on a just upper side, and the second gap 31 is located on a just under side. Meanwhile, here, the width of the second metal laminate sheet 19 is designed slightly wider than the width of the first metal laminate sheet 17 to make the first gap 25 and the second gap 31 the same width.

However, the second metal laminate sheet 19 and the first metal laminate sheet 17 may be made the same width.

Then, the second middle rubber layer 11 of a cylindrical shape is formed on an outer periphery of the second metal laminate sheet 19 by extrusion, the reinforcing layer 13 of a cylindrical shape is provided on an outer periphery of the second middle rubber layer 11, and then the outer surface rubber layer 15 of a cylindrical shape is formed on an outermost side by extrusion. Next, the inner surface rubber layer 3, the first middle rubber layer 7, the second middle rubber layer 11 and the outer surface rubber layer 15 are vulcanized, and thereby the low-permeable composite hose 1 is completed. Meanwhile, the second middle rubber layer 11 may be thinly laminated over an outer surface of the second metal laminate sheet 19 before the second metal laminate sheet 19 is rolled.

The low-permeable composite hose of the present invention is used, for example, for a piping in a motor vehicle, and conveys an internal fluid without allowing it to disperse outside for a long period of time.

What is claimed is:

1. A low-permeable composite hose, comprising:
a first impermeable layer formed by rolling a first metal laminate sheet in a form of strip into a cylindrical shape so that widthwise opposite edges of the first metal laminate sheet extend in a longitudinal direction of the low-permeable composite hose,
a second impermeable layer formed on an outer side of the first impermeable layer by rolling a second metal laminate sheet in a form of strip into a cylindrical shape so that widthwise opposite edges of the second metal laminate sheet extend in the longitudinal direction,
a rubber elastic layer interposed between the first and the second impermeable layers,
a first gap being defined between the widthwise opposite edges of the first metal laminate sheet in the first impermeable layer and a second gap being defined between the widthwise opposite edges of the, second metal laminate sheet in the second impermeable layer, and
the widthwise opposite edges of the first metal laminate sheet and the widthwise opposite edges of the second metal laminate sheet being disposed so as to be staggered with respect to each other in a circumferential direction.

2. The low-permeable composite hose as set forth in claim 1, wherein the widthwise opposite edges of the first metal laminate sheet is located on a diametrically opposite side of the widthwise opposite edges of the second metal laminate sheet.

3. A low-permeable composite hose, comprising:
a plurality of impermeable layers, each formed by rolling a metal laminate sheet in a form of strip into a cylindrical shape so that widthwise opposite edges of the metal laminate sheet extend in a longitudinal direction of the low-permeable composite hose,
a rubber elastic layer interposed between the impermeable layers,
a gap being defined between the widthwise opposite edges of the metal laminate sheet in each of the impermeable layers, and
each of the metal laminate sheets being disposed so that the widthwise opposite edges of the metal laminate sheet is staggered with respect to the widthwise opposite edges of an adjacent metal laminate sheet in a circumferential direction.
